(19) United States
(12) Patent Application Publication
(10) Pub. No.: US 2018/0220622 A1
(43) Pub. Date: Aug. 9, 2018

(54) Animal Bathing System

(71) Applicant: Gloria McLaughlin, West Seneca, NY (US)

(72) Inventor: Gloria McLaughlin, West Seneca, NY (US)

(21) Appl. No.: 15/425,369

(22) Filed: Feb. 6, 2017

(51) Int. Cl. A01K 13/00; F16B 47/00; F16M 13/02; A01K 15/04; A47K 3/00

(52) U.S. Cl. CPC A01K 13/001; F16B 47/00; A47K 3/001; A01K 15/04; F16M 13/022

(57) ABSTRACT

An animal bathing system includes a tub that that is selectively filled with a fluid thereby facilitating an animal to be bathed in the tub. A pair of tethering units is provided and each of the tethering units suctionally engages the outer wall of the tub. In this way each of the tethering units is removably retained on the tub. Each of the tethering units is removably coupled to the animal thereby inhibiting the animal from escaping the tub when the animal is bathed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to bathing devices and more particularly pertains to a new bathing device for restraining an animal when the animal is bathed.

### BRIEF SUMMARY OF THE INVENTION

An embodiment of the disclosure meets the needs presented above by generally comprising a tub that that is selectively filled with a fluid thereby facilitating an animal to be bathed in the tub. A pair of tethering units is provided and each of the tethering units suctionally engages the outer wall of the tub. In this way each of the tethering units is removably retained on the tub. Each of the tethering units is removably coupled to the animal thereby inhibiting the animal from escaping the tub when the animal is bathed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tethering unit of an animal bathing system according to an embodiment of the disclosure.

FIG. 2 is a bottom view of a tethering unit of an embodiment of the disclosure.

FIG. 3 is a front view of a tethering unit an embodiment of the disclosure.

FIG. 4 is a top view of tethering unit of an embodiment of the disclosure.

FIG. 5 is a perspective in use view of an embodiment of the disclosure.

### DETAILED DESCRIPTION OF THE INVENTION

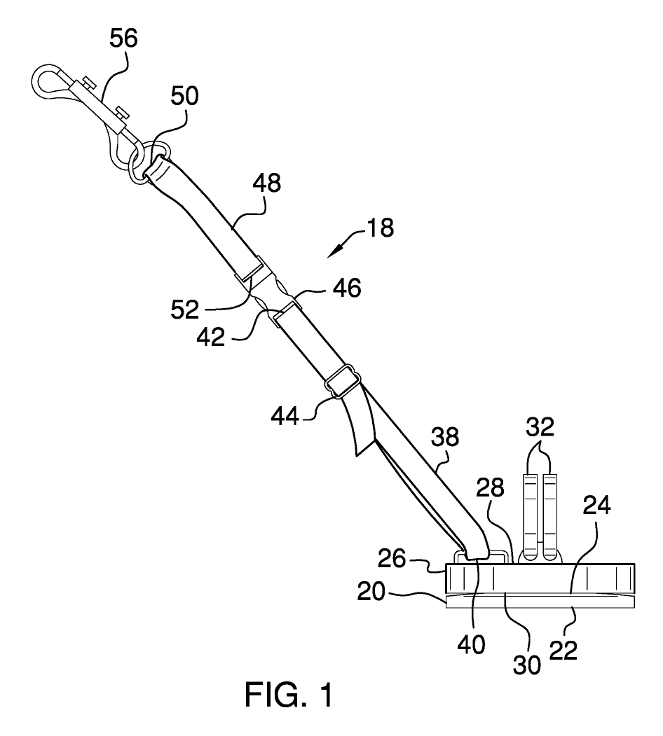

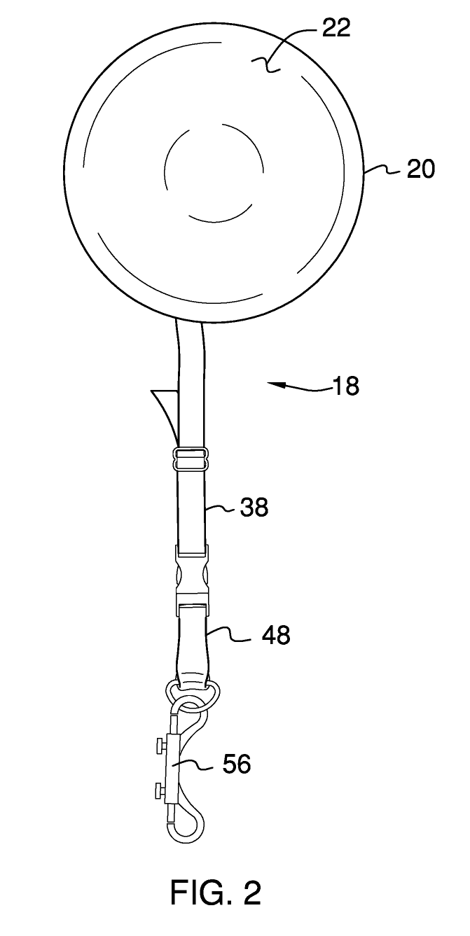

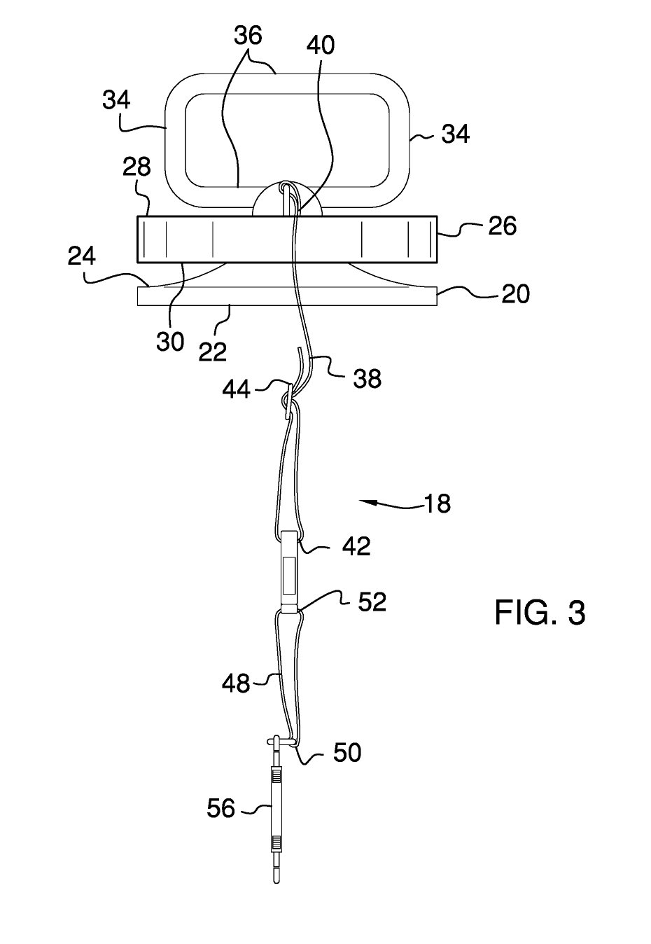

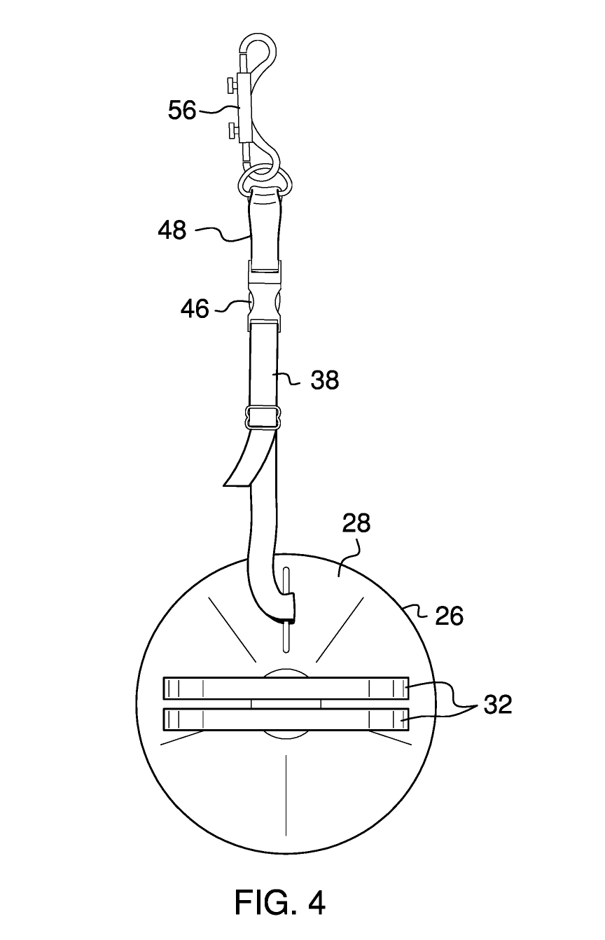

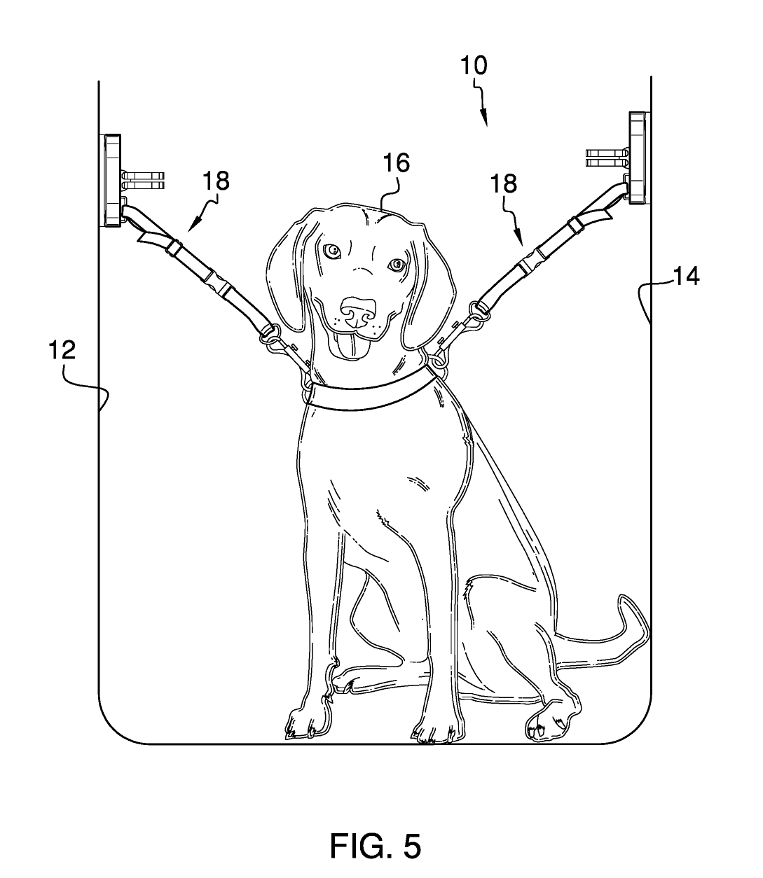

With reference now to the drawings, and in particular to FIGS. 1 through 5 thereof, a new bathing device embodying the principles and concepts of an embodiment of the disclosure and generally designated by the reference numeral 10 will be described.

As best illustrated in FIGS. 1 through 5, the animal bathing system 10 generally comprises a tub 12 that has an outer wall 14. The tub 12 is selectively filled with a fluid thereby facilitating an animal 16 to be bathed in the tub 12. The fluid may be water and the animal 16 may be a dog. Additionally, the tub 12 may be a bathtub, a shower enclosure or any other type of tub.

A pair of tethering units 18 is provided and each of the tethering units 18 suctionally engages the outer wall 14 of the tub 12. In this way each of the tethering units 18 is removably retained on the tub 12. Each of the tethering units 18 is removably coupled to the animal 16 thereby inhibiting the animal 16 from escaping the tub 12 when the animal 16 is bathed.

Each of the tethering units 18 comprises a suction cup 20 that has a first surface 22 and a second surface 24. The first surface 22 is concavely arcuate with respect to the second surface 24 and the first surface 22 is selectively urged to engage the outer wall 14 of the tub 12. In this way the suction cup 20 is suctionally retained on the outer wall 14. The suction cup 20 may be comprised of a resiliently deformable material such as rubber or the like.

A disk 26 is provided that has a first side 28 and a second side 30 and the second side 30 is coupled to the second surface 24 of the suction cup 20. A pair of handles 32 is provided and each of the handles 32 is coupled to the first side 28 of the disk 26. Each of the handles 32 is selectively gripped to manipulate the suction cup 20. Each of the handles 32 comprises a pair of vertical arms 34 extending between a pair of horizontal arms 36. One of the horizontal arms 36 corresponding to each of the handles 32 is coupled to the first side 28 of the disk 26. Moreover, the handles 32 are aligned with each other on the disk 26.

A first strap 38 is provided that has a first end 40 and a second end 42. The first end 40 is coupled to the first side 28 of the disk 26. A buckle 44 is slidably positioned on the first strap 38 and the buckle 44 is selectively manipulated. The first strap 38 loops through the buckle 44 such that the buckle 44 selectively adjusts a length of the first strap 38. A first coupler 46 is coupled to the second end 42 of the first strap 38.

A second strap 48 is provided that has a primary end 50 and a secondary end 52. A second coupler 54 is coupled to the secondary end 52 and the second coupler 54 releasably engages the first coupler 46. In this way the second strap 48 is removably coupled to the first strap 38. A fastener 56 is releasably coupled to the primary end 50 of the second strap 48. The fastener 56 is selectively and releasably coupled to a collar on the animal 16 thereby facilitating the animal 16 to be tethered to the tub 12. The fastener 56 may be a double lobster claw clasp or the like.

In use, the suction cup 20 corresponding to each of the tethering units 18 is manipulated to suctionally engage the outer wall 14 of the tub 12. Moreover, the tethering units 18 are positioned on opposite sides of the tub 12 from each other. The fastener 56 corresponding to each of the tethering units 18 is releasably coupled to the collar on the animal 16. The buckle 44 corresponding to each of the tethering units 18 is manipulated to take up slack in the first strap 38 corresponding to each other tethering units 18. In this way the animal 16 is restrained in a selected position in the tub 12 for bathing. Additionally, the tethering units 18 inhibit the animal 16 from escaping the tub 12 while the animal 16 is bathed. The animal 16 is released from each of the tethering units 18 when the animal 16 is finished being bathed.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal bathing system comprising:
a tub having an outer wall, said tub being configured to be filled with a fluid thereby facilitating an animal to be bathed in said tub; and
a pair of tethering units, each of said tethering units suctionally engaging said outer wall of said tub such that each of said tethering units is removably retained on said tub, each of said tethering units being configured to be removably coupled to the animal thereby inhibiting the animal from escaping said tub when the animal is bathed.

2. The system according to claim 1, wherein each of said tethering units comprises a suction cup having a first surface and a second surface, said first surface being concavely arcuate with respect to said second surface, said first surface being urged to engage said outer wall of said tub such that said suction cup is suctionally retained on said outer wall.

3. The system according to claim 2, further comprising a disk having a first side and a second side, said second side being coupled to said second surface of said suction cup.

4. The system according to claim 3, further comprising a pair of handles, each of said handles being coupled to said first side of said disk wherein each of said handles is configured to be gripped, each of said handles comprising a pair of vertical arms extending between a pair of horizontal arms, one of said horizontal arms corresponding to each of said handles being coupled to said first side of said disk, said handles being aligned with each other on said disk.

5. The system according to claim 1, further comprising:
a disk having a first side; and
a first strap having a first end and a second end, said first end being coupled to said first side of said disk.

6. The system according to claim 5, further comprising a buckle being slidably positioned on said first strap wherein said buckle is configured to be manipulated, said first strap extending through said buckle such that said buckle adjusts a length of said first strap.

7. The system according to claim 5, further comprising a first coupler being coupled to said second end of said first strap.

8. The system according to claim 1, further comprising a second strap having a primary end and a secondary end.

9. The system according to claim 8, further comprising:
a first strap;
a first coupler being coupled to said first strap; and
a second coupler being coupled to said secondary end, said second coupler releasably engaging said first coupler such that said second strap is removably coupled to said first strap.

10. The system according to claim 9, further comprising a fastener releasably coupled to said primary end of said second strap, said fastener being configured to be releasably coupled to a collar on the animal thereby facilitating the animal to be tethered to said tub.

11. An animal bathing system comprising:
a tub having an outer wall, said tub being configured to be filled with a fluid thereby facilitating an animal to be bathed in said tub; and
a pair of tethering units, each of said tethering units suctionally engaging said outer wall of said tub such that each of said tethering units is removably retained on said tub, each of said tethering units being configured to be removably coupled to the animal thereby inhibiting the animal from escaping said tub when the animal is bathed, each of said tethering units comprising:
a suction cup having a first surface and a second surface, said first surface being concavely arcuate with respect to said second surface, said first surface being urged to engage said outer wall of said tub such that said suction cup is suctionally retained on said outer wall,
a disk having a first side and a second side, said second side being coupled to said second surface of said suction cup,
a pair of handles, each of said handles being coupled to said first side of said disk wherein each of said handles is configured to be gripped, each of said handles comprising a pair of vertical arms extending between a pair of horizontal arms, one of said horizontal arms corresponding to each of said handles being coupled to said first side of said disk, said handles being aligned with each other on said disk,
a first strap having a first end and a second end, said first end being coupled to said first side of said disk,
a buckle being slidably positioned on said first strap wherein said buckle is configured to be manipulated, said first strap extending through said buckle such that said buckle adjusts a length of said first strap,
a first coupler being coupled to said second end of said first strap,
a second strap having a primary end and a secondary end,
a second coupler being coupled to said secondary end, said second coupler releasably engaging said first coupler such that said second strap is removably coupled to said first strap, and
a fastener releasably coupled to said primary end of said second strap, said fastener being configured to be releasably coupled to a collar on the animal thereby facilitating the animal to be tethered to said tub.
